(19) United States
(12) Patent Application Publication
(10) Pub. No.: US 2023/0073048 A1
(43) Pub. Date: Mar. 9, 2023

(54) HIGH-THROUGHPUT TESTING AND MODULE INTEGRATION OF ROTATIONALLY VARIANT OPTICAL LENS SYSTEMS

(71) Applicant: Meta Platforms Technologies, LLC, Menlo Park, CA (US)

(72) Inventors: Di XU, Rochester, NY (US); Chadwick Brian MARTIN, Kirkland, WA (US); Fei LIU, Los Altos, CA (US)

(73) Assignee: Meta Platforms Technologies, LLC, Menlo Park, CA (US)

(21) Appl. No.: 17/470,952

(22) Filed: Sep. 9, 2021

(51) Int. Cl. G01M 11/02; G01N 21/958

(52) U.S. Cl. CPC G01M 11/0235; G01M 11/0207; G01N 21/958; G01N 2021/9583

(57) ABSTRACT

A system and method for high-throughput testing and module integration of rotationally variant optical lens systems is provided. In some examples, the system may be a metrology system that includes a light source to generate optical illumination. The metrology system may also include a null element. The null element may generate, using the optical illumination from the light source, a prescribed wavefront corresponding to a unit under test (UUT). In addition, the metrology system may further include a null element fixture to position the null element with respect to the unit under test (UUT).

### TECHNICAL FIELD

This patent application relates generally to optical lens design and configurations in optical systems, such as head-mounted displays (HMDs), and more specifically, to systems and methods for high-throughput testing and module integration of rotationally variant optical lens systems.

### BACKGROUND

Optical lens design and configurations are part of many modern-day devices, such as cameras used in mobile phones and various optical devices. One such optical device that relies on optical lens design is a head-mounted display (HMD). In some examples, a head-mounted display (HMD) may be a headset or eyewear used for video playback, gaming, or sports, and in a variety of contexts and applications, such as virtual reality (VR), augmented reality (AR), or mixed reality (MR).

Some head-mounted displays (HMDs) rely on lens designs or configurations that are lighter and less bulky. For instance, rotationally variant optics, or “freeform” optics, is an emerging technology that uses lens and/or mirror surfaces that lack an axis of symmetry. This lack of symmetry can help spread of light and ultimately create an optical device with a higher resolution and a smaller form factor. A camera lens for eye-tracking components or systems in a head mounted-display (HMD), for example, may be highly freeform or rotationally variant. However, there are notable challenges involving manufacturing and integration of such freeform optical components.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a system associated with a head-mounted display (HMD), according to an example.

FIGS. 2A-2B illustrate various head-mounted displays (HMDs), in accordance with an example.

FIGS. 3A-3B illustrate diagrams of various optical assemblies using rotationally variant optics, according to an example.

FIGS. 4A-4F illustrate graphs of various through-focus modulation transfer function (MTF) curves for rotationally invariant/variant optics, according to an example.

FIG. 5 illustrates a flow chart of a method for creating or designing a nulling apparatus or element for mass production (MP) metrology of rotationally variant optics, according to an example.

FIGS. 6A-6E illustrate block diagrams of various optical assemblies using rotationally variant optics with or without a nulling corrector, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

There are many types of optical devices that utilize optical design configurations. For example, a head-mounted display (HMD) is an optical device that may communicate information to or from a user who is wearing the headset. For example, a virtual reality (VR) headset may be used to present visual information to simulate any number of virtual environments when worn by a user. That same virtual reality (VR) headset may also receive information from the users eye movements, head/body shifts, voice, or other user-provided signals.

In many cases, optical lens design configurations seek to decrease headset size, weight, cost, and overall bulkiness. However, these attempts to provide a cost-effective device with a small form factor often limits the function of the head-mounted display (HMD). For example, while attempts to reduce the size and bulkiness of various optical configurations in conventional headsets can be achieved, this often reduces the amount of space needed for other built-in features of a headset, thereby restricting or limiting a headsets ability to function at full capacity.

With regard to rotationally variant (or “freeform”) optics, there are several challenges in manufacturing and integration of such optics. Manufacturers may typically rely on test data to iteratively tune manufacturing processes to meet performance specifications. Because rotationally variant optical components, by definition, have an asymmetrical geometry, it may be difficult to manufacture such components in a repeatable, reliable, and efficient fashion, especially in high volumes.

In addition to manufacturing, optical component integration may be another technical challenge as well. For instance, integrating lens module housing with a sensor (e.g., in a camera assembly for eye-tracking in an augmented reality (AR) headset) may involve any number of specific and nuanced processes that may require accurate and repeatable execution, and again, especially in scale. More specifically, the lens module housing may need to be integrated with the sensor via any number of active alignment (AA) processes. Such alignment processes may require use of through-focus modulation transfer function (MTF) curves that are collected over a camera field of view (FOV) to position the sensor where the curves peak together.

The systems and methods described herein may provide for high-throughput testing and module integration of rotationally variant optical lens systems. In this way, a new mass production (MP) metrology for freeform lens and/or camera modules may be provided. Among many key advantages and benefits, the systems and methods described herein may enable improved techniques for iterative tuning, which may be utilized during manufacturing by a manufacturer of rotationally variant or freeform optics, for example, to optimize lens/optics manufacturing processes and ultimately increase quality and yield. Moreover, the systems and methods described herein may also provide high-throughput testing and integration for camera and sensor modules. These and other examples may be provided in the detailed description below.

It should also be appreciated that the systems and methods described herein may be particularly suited for virtual reality (VR), augmented reality (AR), and/or mixed reality (MR) environments, but may also be applicable to a host of other systems or environments that include optical lens assemblies, e.g., those using rotationally variant or freeform optics, or other similar optical configurations. These may include, for example, cameras or sensors, networking, telecommunications, holography, telescopes, spectrometers, or other optical systems, such as any system or method for forming images or projecting images. Thus, the optical configurations described herein, may be used in any of these or other examples. These and other benefits will be apparent in the description provided herein.

### System Overview

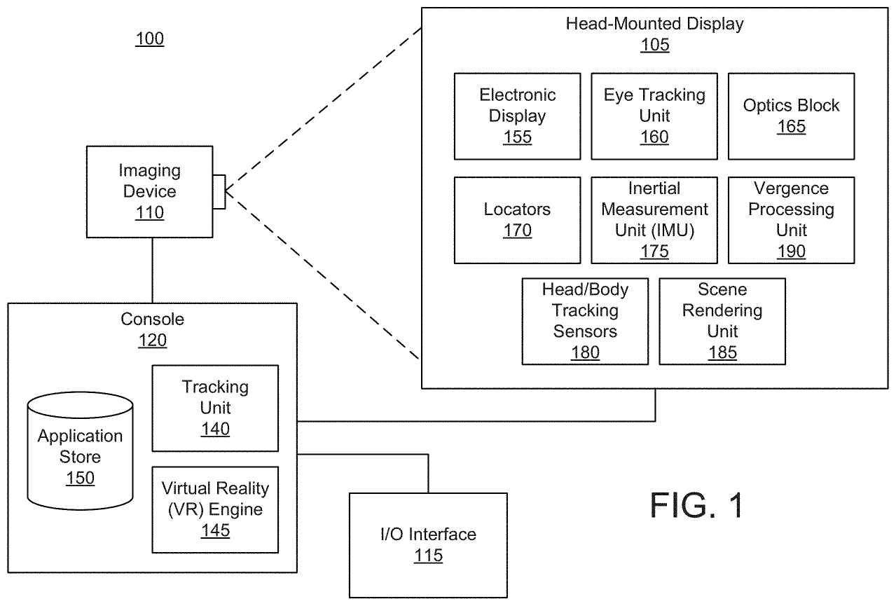

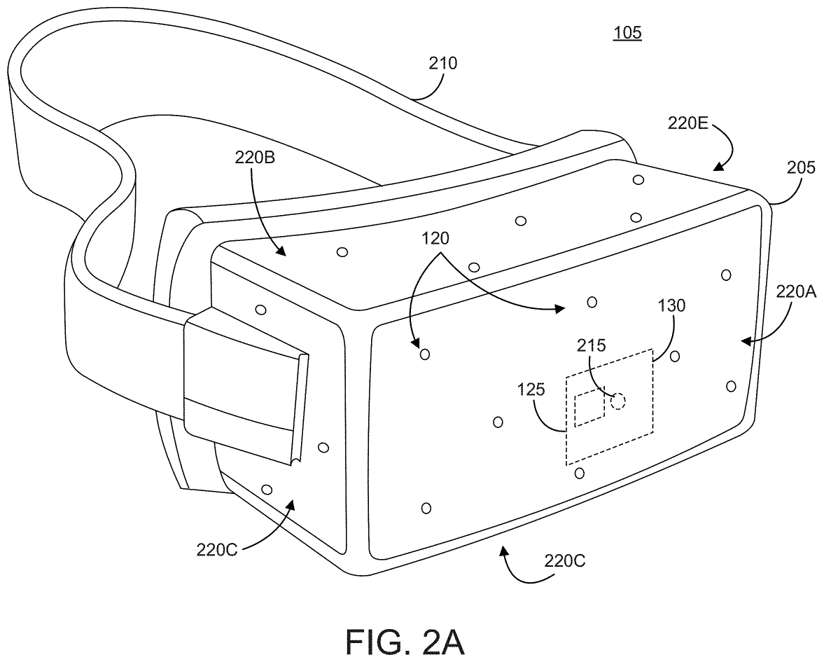

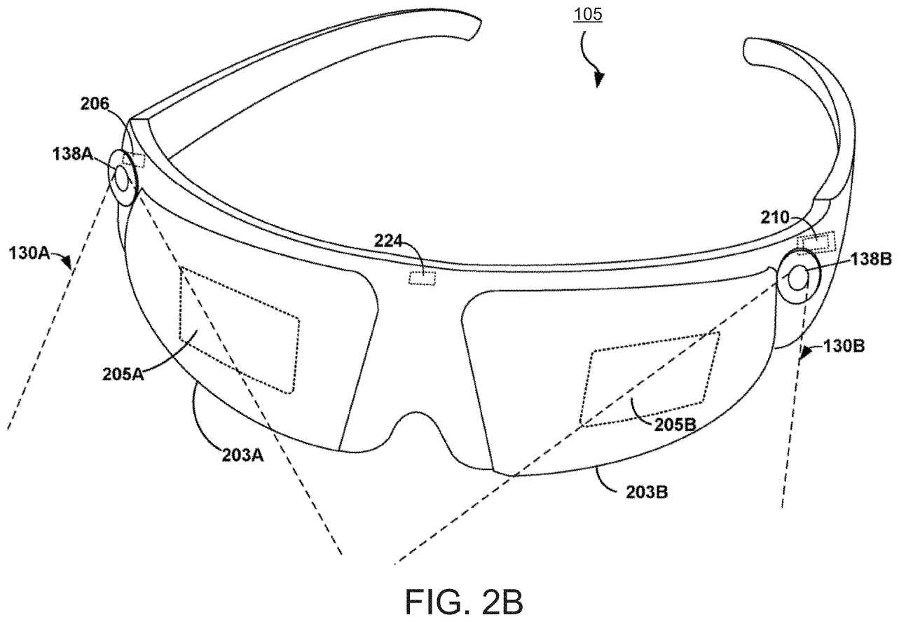

Reference is made to FIGS. 1 and 2A-2B. FIG. 1 illustrates a block diagram of a system 100 associated with a head-mounted display (HMD), according to an example. The system 100 may be used as a virtual reality (VR) system, an augmented reality (AR) system, a mixed reality (MR) system, or some combination thereof, or some other related system. It should be appreciated that the system 100 and the head-mounted display (HMD) 105 may be exemplary illustrations. Thus, the system 100 and/or the head-mounted display (HMD) 105 may or not include additional features and some of the features described herein may be removed and/or modified without departing from the scopes of the system 100 and/or the head-mounted display (HMD) 105 outlined herein.

In some examples, the system 100 may include the head-mounted display (HMD) 105, an imaging device 110, and an input/output (I/O) interface 115, each of which may be communicatively coupled to a console 120 or other similar device.

While FIG. 1 shows a single head-mounted display (HMD) 105, a single imaging device 110, and an I/O interface 115, it should be appreciated that any number of these components may be included in the system 100. For example, there may be multiple head-mounted displays (HMDs) 105, each having an associated input/output (I/O) interface 115 and being monitored by one or more imaging devices 110, with each head-mounted display (HMD) 105, I/O interface 115, and imaging devices 110 communicating with the console 120. In alternative configurations, different and/or additional components may also be included in the system 100. As described herein, the head-mounted display (HMD) 105 may act be used as a virtual reality (VR), augmented reality (AR), and/or a mixed reality (MR) head-mounted display (HMD). A mixed reality (MR) and/or augmented reality (AR) head-mounted display (HMD), for instance, may augment views of a physical, real-world environment with computer-generated elements (e.g., images, video, sound, etc.).

The head-mounted display (HMD) 105 may communicate information to or from a user who is wearing the headset. In some examples, the head-mounted display (HMD) 105 may provide content to a user, which may include, but not limited to, images, video, audio, or some combination thereof. In some examples, audio content may be presented via a separate device (e.g., speakers and/or headphones) external to the head-mounted display (HMD) 105 that receives audio information from the head-mounted display (HMD) 105, the console 120, or both. In some examples, the head-mounted display (HMD) 105 may also receive information from a user. This information may include eye moments, head/body movements, voice (e.g., using an integrated or separate microphone device), or other user-provided content.

The head-mounted display (HMD) 105 may include any number of components, such as an electronic display 155, an eye tracking unit 160, an optics block 165, one or more locators 170, an inertial measurement unit (IMU) 175, one or head/body tracking sensors 180, and a scene rendering unit 185, and a vergence processing unit 190.

While the head-mounted display (HMD) 105 described in FIG. 1 is generally within a VR context as part of a VR system environment, the head-mounted display (HMD) 105 may also be part of other HMD systems such as, for example, an AR system environment. In examples that describe an AR system or MR system environment, the head-mounted display (HMD) 105 may augment views of a physical, real-world environment with computer-generated elements (e.g., images, video, sound, etc.).

An example of the head-mounted display (HMD) 105 is further described below in conjunction with FIG. 2. The head-mounted display (HMD) 105 may include one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The electronic display 155 may include a display device that presents visual data to a user. This visual data may be transmitted, for example, from the console 120. In some examples, electronic display 155 may also present tracking light for tracking the user's eye movements. It should be appreciated that the electronic display 155 may include any number of electronic display elements (e.g., a display for each of the user). Examples of a display device that may be used in the electronic display 155 may include, but not limited to a liquid crystal display (LCD), a light emitting diode (LED), an organic light emitting diode (OLED) display, an active-matrix organic light-emitting diode (AMOLED) display, micro light emitting diode (micro-LED) display, some other display, or some combination thereof.

The optics block 165 may adjust its focal length based on or in response to instructions received from the console 120 or other component. In some examples, the optics block 165 may include a multi multifocal block to adjust a focal length (adjusts optical power) of the optics block 165.

The eye tracking unit 160 may track an eye position and eye movement of a user of the head-mounted display (HMD) 105. A camera or other optical sensor inside the head-mounted display (HMD) 105 may capture image information of a user's eyes, and the eye tracking unit 160 may use the captured information to determine interpupillary distance, interocular distance, a three-dimensional (3D) position of each eye relative to the head-mounted display (HMD) 105 (e.g., for distortion adjustment purposes), including a magnitude of torsion and rotation (i.e., roll, pitch, and yaw) and gaze directions for each eye. The information for the position and orientation of the user's eyes may be used to determine the gaze point in a virtual scene presented by the head-mounted display (HMD) 105 where the user is looking.

The vergence processing unit 190 may determine a vergence depth of a user's gaze. In some examples, this may be based on the gaze point or an estimated intersection of the gaze lines determined by the eye tracking unit 160. Vergence is the simultaneous movement or rotation of both eyes in opposite directions to maintain single binocular vision, which is naturally and/or automatically performed by the human eye. Thus, a location where a user's eyes are verged may refer to where the user is looking and may also typically be the location where the user's eyes are focused. For example, the vergence processing unit 190 may triangulate the gaze lines to estimate a distance or depth from the user associated with intersection of the gaze lines. The depth associated with intersection of the gaze lines can then be used as an approximation for the accommodation distance, which identifies a distance from the user where the user's eyes are directed. Thus, the vergence distance allows determination of a location where the user's eyes should be focused.

The one or more locators 170 may be one or more objects located in specific positions on the head-mounted display (HMD) 105 relative to one another and relative to a specific reference point on the head-mounted display (HMD) 105. A locator 170, in some examples, may be a light emitting diode (LED), a corner cube reflector, a reflective marker, and/or a type of light source that contrasts with an environment in which the head-mounted display (HMD) 105 operates, or some combination thereof. Active (or passive) locators 170 (e.g., an LED or other type of light emitting device) may emit light in the visible band (^{˜}380 nm to 850 nm), in the infrared (IR) band (^{˜}850 nm to 1 mm), in the ultraviolet band (10 nm to 380 nm), some other portion of the electromagnetic spectrum, or some combination thereof.

The one or more locators 170 may be located beneath an outer surface of the head-mounted display (HMD) 105, which may be transparent to wavelengths of light emitted or reflected by the locators 170 or may be thin enough not to substantially attenuate wavelengths of light emitted or reflected by the locators 170. Further, the outer surface or other portions of the head-mounted display (HMD) 105 may be opaque in the visible band of wavelengths of light. Thus, the one or more locators 170 may emit light in the IR band while under an outer surface of the head-mounted display (HMD) 105 that may be transparent in the IR band but opaque in the visible band.

The inertial measurement unit (IMU) 175 may be an electronic device that generates, among other things, fast calibration data based on or in response to measurement signals received from one or more of the head/body tracking sensors 180, which may generate one or more measurement signals in response to motion of head-mounted display (HMD) 105. Examples of the head/body tracking sensors 180 may include, but not limited to, accelerometers, gyroscopes, magnetometers, cameras, other sensors suitable for detecting motion, correcting error associated with the inertial measurement unit (IMU) 175, or some combination thereof. The head/body tracking sensors 180 may be located external to the inertial measurement unit (IMU) 175, internal to the inertial measurement unit (IMU) 175, or some combination thereof.

Based on or in response to the measurement signals from the head/body tracking sensors 180, the inertial measurement unit (IMU) 175 may generate fast calibration data indicating an estimated position of the head-mounted display (HMD) 105 relative to an initial position of the head-mounted display (HMD) 105. For example, the head/body tracking sensors 180 may include multiple accelerometers to measure translational motion (forward/back, up/down, left/right) and multiple gyroscopes to measure rotational motion (e.g., pitch, yaw, and roll). The inertial measurement unit (IMU) 175 may then, for example, rapidly sample the measurement signals and/or calculate the estimated position of the head-mounted display (HMD) 105 from the sampled data. For example, the inertial measurement unit (IMU) 175 may integrate measurement signals received from the accelerometers over time to estimate a velocity vector and integrates the velocity vector over time to determine an estimated position of a reference point on the head-mounted display (HMD) 105. It should be appreciated that the reference point may be a point that may be used to describe the position of the head-mounted display (HMD) 105. While the reference point may generally be defined as a point in space, in various examples or scenarios, a reference point as used herein may be defined as a point within the head-mounted display (HMD) 105 (e.g., a center of the inertial measurement unit (IMU) 175). Alternatively or additionally, the inertial measurement unit (IMU) 175 may provide the sampled measurement signals to the console 120, which may determine the fast calibration data or other similar or related data.

The inertial measurement unit (IMU) 175 may additionally receive one or more calibration parameters from the console 120. As described herein, the one or more calibration parameters may be used to maintain tracking of the head-mounted display (HMD) 105. Based on a received calibration parameter, the inertial measurement unit (IMU) 175 may adjust one or more of the IMU parameters (e.g., sample rate). In some examples, certain calibration parameters may cause the inertial measurement unit (IMU) 175 to update an initial position of the reference point to correspond to a next calibrated position of the reference point. Updating the initial position of the reference point as the next calibrated position of the reference point may help reduce accumulated error associated with determining the estimated position. The accumulated error, also referred to as drift error, may cause the estimated position of the reference point to “drift” away from the actual position of the reference point overtime.

The scene rendering unit 185 may receive content for the virtual scene from a VR engine 145 and may provide the content for display on the electronic display 155. Additionally or alternatively, the scene rendering unit 185 may adjust the content based on information from the inertial measurement unit (IMU) 175, the vergence processing unit 830, and/or the head/body tracking sensors 180. The scene rendering unit 185 may determine a portion of the content to be displayed on the electronic display 155 based at least in part on one or more of the tracking unit 140, the head/body tracking sensors 180, and/or the inertial measurement unit (IMU) 175.

The imaging device 110 may generate slow calibration data in accordance with calibration parameters received from the console 120. Slow calibration data may include one or more images showing observed positions of the locators 125 that are detectable by imaging device 110. The imaging device 110 may include one or more cameras, one or more video cameras, other devices capable of capturing images including one or more locators 170, or some combination thereof. Additionally, the imaging device 110 may include one or more filters (e.g., for increasing signal to noise ratio). The imaging device 110 may be configured to detect light emitted or reflected from the one or more locators 170 in a field of view of the imaging device 110. In examples where the locators 170 include one or more passive elements (e.g., a retroreflector), the imaging device 110 may include a light source that illuminates some or all of the locators 170, which may retro-reflect the light towards the light source in the imaging device 110. Slow calibration data may be communicated from the imaging device 110 to the console 120, and the imaging device 110 may receive one or more calibration parameters from the console 120 to adjust one or more imaging parameters (e.g., focal length, focus, frame rate, ISO, sensor temperature, shutter speed, aperture, etc.).

The I/O interface 115 may be a device that allows a user to send action requests to the console 120. An action request may be a request to perform a particular action. For example, an action request may be to start or end an application or to perform a particular action within the application. The I/O interface 115 may include one or more input devices. Example input devices may include a keyboard, a mouse, a hand-held controller, a glove controller, and/or any other suitable device for receiving action requests and communicating the received action requests to the console 120. An action request received by the I/O interface 115 may be communicated to the console 120, which may perform an action corresponding to the action request. In some examples, the I/O interface 115 may provide haptic feedback to the user in accordance with instructions received from the console 120. For example, haptic feedback may be provided by the I/O interface 115 when an action request is received, or the console 120 may communicate instructions to the I/O interface 115 causing the I/O interface 115 to generate haptic feedback when the console 120 performs an action.

The console 120 may provide content to the head-mounted display (HMD) 105 for presentation to the user in accordance with information received from the imaging device 110, the head-mounted display (HMD) 105, or the I/O interface 115. The console 120 includes an application store 150, a tracking unit 140, and the VR engine 145. Some examples of the console 120 have different or additional units than those described in conjunction with FIG. 1. Similarly, the functions further described below may be distributed among components of the console 120 in a different manner than is described here.

The application store 150 may store one or more applications for execution by the console 120, as well as other various application-related data. An application, as used herein, may refer to a group of instructions, that when executed by a processor, generates content for presentation to the user. Content generated by an application may be in response to inputs received from the user via movement of the head-mounted display (HMD) 105 or the I/O interface 115. Examples of applications may include gaming applications, conferencing applications, video playback application, or other applications.

The tracking unit 140 may calibrate the system 100. This calibration may be achieved by using one or more calibration parameters and may adjust one or more calibration parameters to reduce error in determining position of the head-mounted display (HMD) 105. For example, the tracking unit 140 may adjust focus of the imaging device 110 to obtain a more accurate position for observed locators 170 on the head-mounted display (HMD) 105. Moreover, calibration performed by the tracking unit 140 may also account for information received from the inertial measurement unit (IMU) 175. Additionally, if tracking of the head-mounted display (HMD) 105 is lost (e.g., imaging device 110 loses line of sight of at least a threshold number of locators 170), the tracking unit 140 may re-calibrate some or all of the system 100 components.

Additionally, the tracking unit 140 may track the movement of the head-mounted display (HMD) 105 using slow calibration information from the imaging device 110 and may determine positions of a reference point on the head-mounted display (HMD) 105 using observed locators from the slow calibration information and a model of the head-mounted display (HMD) 105. The tracking unit 140 may also determine positions of the reference point on the head-mounted display (HMD) 105 using position information from the fast calibration information from the inertial measurement unit (IMU) 175 on the head-mounted display (HMD) 105. Additionally, the eye tracking unit 160 may use portions of the fast calibration information, the slow calibration information, or some combination thereof, to predict a future location of the head-mounted display (HMD) 105, which may be provided to the VR engine 145.

The VR engine 145 may execute applications within the system 100 and may receive position information, acceleration information, velocity information, predicted future positions, other information, or some combination thereof for the head-mounted display (HMD) 105 from the tracking unit 140 or other component. Based on or in response to the received information, the VR engine 145 may determine content to provide to the head-mounted display (HMD) 105 for presentation to the user. This content may include, but not limited to, a virtual scene, one or more virtual objects to overlay onto a real world scene, etc.

In some examples, the VR engine 145 may maintain focal capability information of the optics block 165. Focal capability information, as used herein, may refer to information that describes what focal distances are available to the optics block 165. Focal capability information may include, e.g., a range of focus the optics block 165 is able to accommodate (e.g., 0 to 4 diopters), a resolution of focus (e.g., 0.25 diopters), a number of focal planes, combinations of settings for switchable half wave plates (SHWPs) (e.g., active or non-active) that map to particular focal planes, combinations of settings for SHWPS and active liquid crystal lenses that map to particular focal planes, or some combination thereof.

The VR engine 145 may generate instructions for the optics block 165. These instructions may cause the optics block 165 to adjust its focal distance to a particular location. The VR engine 145 may generate the instructions based on focal capability information and, e.g., information from the vergence processing unit 190, the inertial measurement unit (IMU) 175, and/or the head/body tracking sensors 180. The VR engine 145 may use information from the vergence processing unit 190, the inertial measurement unit (IMU) 175, and the head/body tracking sensors 180, other source, or some combination thereof, to select an ideal focal plane to present content to the user. The VR engine 145 may then use the focal capability information to select a focal plane that is closest to the ideal focal plane. The VR engine 145 may use the focal information to determine settings for one or more SHWPs, one or more active liquid crystal lenses, or some combination thereof, within the optics block 176 that are associated with the selected focal plane. The VR engine 145 may generate instructions based on the determined settings, and may provide the instructions to the optics block 165.

The VR engine 145 may perform any number of actions within an application executing on the console 120 in response to an action request received from the I/O interface 115 and may provide feedback to the user that the action was performed. The provided feedback may be visual or audible feedback via the head-mounted display (HMD) 105 or haptic feedback via the I/O interface 115.

FIGS. 2A-2B illustrate various head-mounted displays (HMDs), in accordance with an example. FIG. 2A shows a head-mounted display (HMD) 105, in accordance with an example. The head-mounted display (HMD) 105 may include a front rigid body 205 and a band 210. The front rigid body 205 may include an electronic display (not shown), an inertial measurement unit (IMU) 175, one or more position sensors (e.g., head/body tracking sensors 180), and one or more locators 170, as described herein. In some examples, a user movement may be detected by use of the inertial measurement unit (IMU) 175, position sensors (e.g., head/body tracking sensors 180), and/or the one or more locators 170, and an image may be presented to a user through the electronic display based on or in response to detected user movement. In some examples, the head-mounted display (HMD) 105 may be used for presenting a virtual reality, an augmented reality, or a mixed reality environment.

At least one position sensor, such as the head/body tracking sensor 180 described with respect to FIG. 1, may generate one or more measurement signals in response to motion of the head-mounted display (HMD) 105. Examples of position sensors may include: one or more accelerometers, one or more gyroscopes, one or more magnetometers, another suitable type of sensor that detects motion, a type of sensor used for error correction of the inertial measurement unit (IMU) 175, or some combination thereof. The position sensors may be located external to the inertial measurement unit (IMU) 175, internal to the inertial measurement unit (IMU) 175, or some combination thereof. In FIG. 2A, the position sensors may be located within the inertial measurement unit (IMU) 175, and neither the inertial measurement unit (IMU) 175 nor the position sensors (e.g., head/body tracking sensors 180) may or may not necessarily be visible to the user.

Based on the one or more measurement signals from one or more position sensors, the inertial measurement unit (IMU) 175 may generate calibration data indicating an estimated position of the head-mounted display (HMD) 105 relative to an initial position of the head-mounted display (HMD) 105. In some examples, the inertial measurement unit (IMU) 175 may rapidly sample the measurement signals and calculates the estimated position of the head-mounted display (HMD) 105 from the sampled data. For example, the inertial measurement unit (IMU) 175 may integrate the measurement signals received from the one or more accelerometers (or other position sensors) over time to estimate a velocity vector and integrates the velocity vector over time to determine an estimated position of a reference point on the head-mounted display (HMD) 105. Alternatively or additionally, the inertial measurement unit (IMU) 175 may provide the sampled measurement signals to a console (e.g., a computer), which may determine the calibration data. The reference point may be a point that may be used to describe the position of the head-mounted display (HMD) 105. While the reference point may generally be defined as a point in space; however, in practice, the reference point may be defined as a point within the head-mounted display (HMD) 105 (e.g., a center of the inertial measurement unit (IMU) 175).

One or more locators 170, or portions of locators 170, may be located on a front side 220A, a top side 220B, a bottom side 220C, a right side 220D, and a left side 220E of the front rigid body 205 in the example of FIG. 2. The one or more locators 170 may be located in fixed positions relative to one another and relative to a reference point 215. In FIG. 2, the reference point 215, for example, may be located at the center of the inertial measurement unit (IMU) 175. Each of the one or more locators 170 may emit light that is detectable by an imaging device (e.g., camera or an image sensor).

FIG. 2B illustrates a head-mounted displays (HMDs), in accordance with another example. As shown in FIG. 2B, the head-mounted display (HMD) 105 may take the form of a wearable, such as glasses. The head-mounted display (HMD) 105 of FIG. 2B may be another example of the head-mounted display (HMD) 105 of FIG. 1. The head-mounted display (HMD) 105 may be part of an artificial reality (AR) system, or may operate as a stand-alone, mobile artificial realty system configured to implement the techniques described herein.

In some examples, the head-mounted display (HMD) 105 may be glasses comprising a front frame including a bridge to allow the head-mounted display (HMD) 105 to rest on a users nose and temples (or “arms”) that extend over the user's ears to secure the head-mounted display (HMD) 105 to the user. In addition, the head-mounted display (HMD) 105 of FIG. 2B may include one or more interior-facing electronic displays 203A and 203B (collectively, “electronic displays 203”) configured to present artificial reality content to a user and one or more varifocal optical systems 205A and 205B (collectively, “varifocal optical systems 205”) configured to manage light output by interior-facing electronic displays 203. In some examples, a known orientation and position of display 203 relative to the front frame of the head-mounted display (HMD) 105 may be used as a frame of reference, also referred to as a local origin, when tracking the position and orientation of the head-mounted display (HMD) 105 for rendering artificial reality (AR) content, for example, according to a current viewing perspective of the head-mounted display (HMD) 105 and the user.

As further shown in FIG. 2B, the head-mounted display (HMD) 105 may further include one or more motion sensors 206, one or more integrated image capture devices 138A and 138B (collectively, “image capture devices 138”), an internal control unit 210, which may include an internal power source and one or more printed-circuit boards having one or more processors, memory, and hardware to provide an operating environment for executing programmable operations to process sensed data and present artificial reality content on display 203. These components may be local or remote, or a combination thereof.

Although depicted as separate components in FIG. 1, it should be appreciated that the head-mounted display (HMD) 105, the imaging device 110, the I/O interface 115, and the console 120 may be integrated into a single device or wearable headset. For example, this single device or wearable headset (e.g., the head-mounted display (HMD) 105 of FIGS. 2A-2B) may include all the performance capabilities of the system 100 of FIG. 1 within a single, self-contained headset. Also, in some examples, tracking may be achieved using an “inside-out” approach, rather than an “outside-in” approach. In an “inside-out” approach, an external imaging device 110 or locators 170 may not be needed or provided to system 100. Moreover, although the head-mounted display (HMD) 105 is depicted and described as a “headset.” it should be appreciated that the head-mounted display (HMD) 105 may also be provided as eyewear or other wearable device (on a head or other body part), as shown in FIG. 2A. Other various examples may also be provided depending on use or application.

### Rotationally Variant Optics

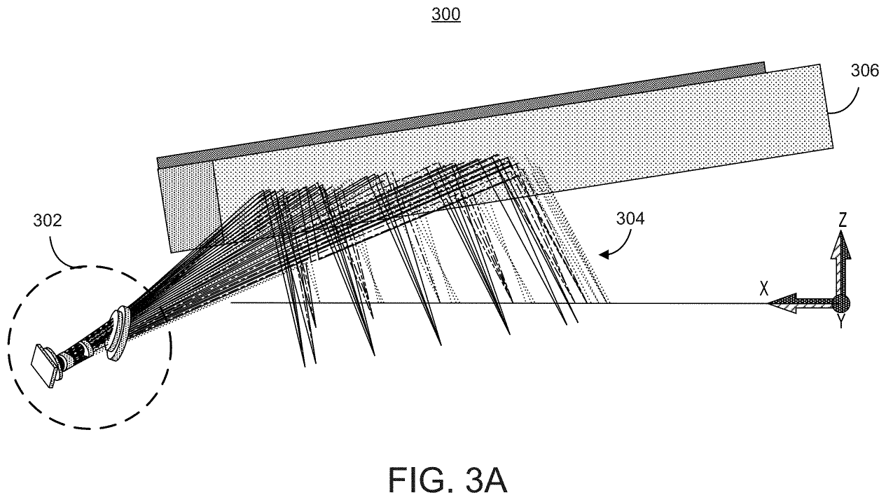

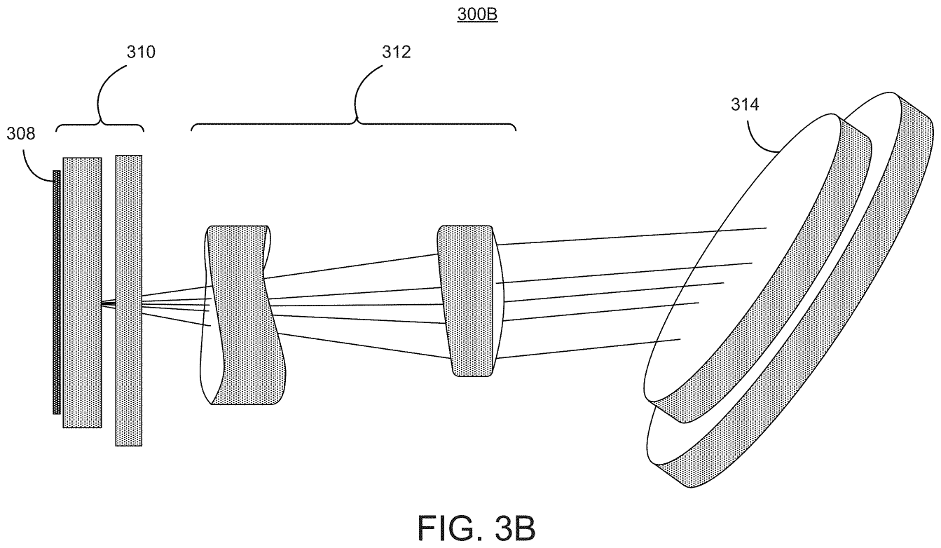

FIGS. 3A-3B illustrate diagrams of an optical assembly 300 using rotationally variant optics, according to an example. FIG. 3A illustrates a view of an optical assembly 300 using an optical system 302 using rotationally variant optics. In some examples, the optical system 302 may be a camera lens assembly for an eye-tracking component of the head-mounted display (HMD) 105 of FIGS. 1-2. Optical illumination 304 may traverse through a reflective element 306 and end up at the optical system 302 of the optical assembly 300.

The reflective element 306 may include any number of reflective materials, such as a glass plate, a waveguide, a holographic optical element (HOE), or combination thereof, or other element.

FIG. 3B illustrates a more detailed version of the optical system 302 using rotationally variant optics the optical assembly 300 of FIG. 3A. The optical system 302 may include any number of optical components, such as a sensor element 308, at least one optical component 310, at least one rotationally variant optical component 312, and element 314.

In some examples, the sensor element 308 may be any sensor or sensor-like element to receive photo-illumination or optical signals. In some examples, the sensor element may include any number of photodetectors or photodiodes. The at least one optical component 310 may include any number of optical components. In some examples, the at least one optical component 310 may be similar to the optics block 165 described with respect to FIG. 1. For example, the at least one optical component 310 may include at least one optical component found in any number of optical stacks, such as a lens, a collimator, a grating, a waveguide, a waveplate, or other similar optical component. In some examples, the at least one optical component 310 may be a cover glass and/or a bandpass filter. The element 314, as shown herein, may have several general functions. First, the element 314 may include a cover window to provide protection from the outside world. After all, in some examples, the entire optical system 300 may be positioned inside a temple arm of a head-mounted display (HMD) 105, thus warranting some measure of protection since this area is relatively delicate and subject to any number of environmental stresses. Second, element 314 may also include a compensator or other similar component to provide compensation for any misalignment between the sensor element 308 or other components and/or the reflective element 306.

The at least one rotationally variant optical component 312 may include any number of freeform optical components. As described herein, the rotationally variant optical component 312 may have an asymmetrical folded geometry. In some examples, the asymmetrical surface of the rotationally variant optical component 312 may help provide greater spread or dispersion of the optical illumination 304. This, in turn, may provide enhanced performance, smaller packaging or form factor, and other various benefits in AR/VR/MR environments.

It should also be appreciated that the at least one rotationally variant optical component 312 may not be limited to only structurally rotationally variant optics or freeform optics, but may also include, for example, any off-center or off-axis portion of a rotationally symmetrical optical component (or surface) or rotationally symmetrical optical component that may be tilted. In other words, the at least one rotationally variant optical component 312, as described herein, may involve any asymmetrical surface/part or any symmetrical surface/part that is used in asymmetrical (or similar) ways to exhibit asymmetrical-like characteristics.

### Manufacturing and Sensor Integration of Rotationally Variant Optics

As described above, there may be manufacturing and integration challenges associated with rotationally variant (or freeform) optical components used in any number of AR/VR/MR headsets, cameras, or other similar optical systems. Manufacturers and suppliers of rotationally variant optical components, for example, may rely on test data to iteratively tune the various processes and techniques to provide optical components that meet one or more performance specifications.

It should be appreciated that for conventional rotationally invariant lenses, nominal performance is generally high and therefore straightforward to compare against in lens process tuning. For instance, through-focus modulation transfer function (MTF) curves associated with rotationally invariant lenses may generally have peaks that tend to be well-behaved. In additional, these through-focus modulation transfer function (MTF) curves may also line up with each other during active alignment (AA).

For rotationally variant, highly freeform, or complex geometrical lenses or similar optical components, nominal performance, in part due to intrinsic higher levels of distortion, may be different relative to conventional rotationally invariant optics. In some scenarios, the modulation transfer function (MTF) curves for rotationally variant or freeform lenses may be higher than a rotationally symmetrical lenses attempting to perform the same or similar function (e.g., correct asymmetric aberration content) because a rotationally symmetrical component may not be able to perform this function.

In particular, one of the functions of the optical system 302 may be to compensate for any aberration introduced by reflective element 306, for example, and work in concert with all relevant optical components to provide high quality imaging. However, lens manufacturers and/or sensor module integrators generally test the lens or optical system 302 by itself (e.g., without access to the reflective element 306). In many ways, this may introduce inherent challenges to the overall testing process. For example, through-focus modulation transfer function (MTF) curves may not line up even in nominal design. It should be appreciated that even if everything were made perfect and ideal, this would not be the case. Thus, this may necessarily create challenges, for example, in lens process tuning and/or camera module integration.

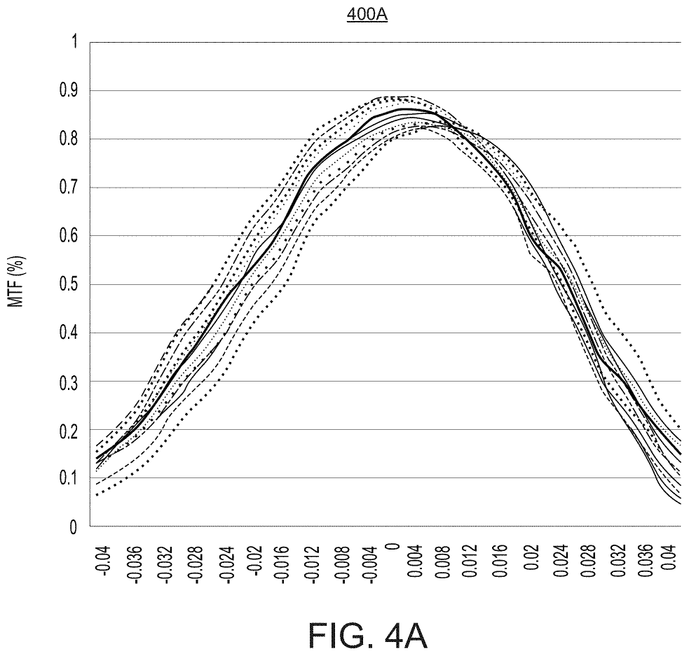

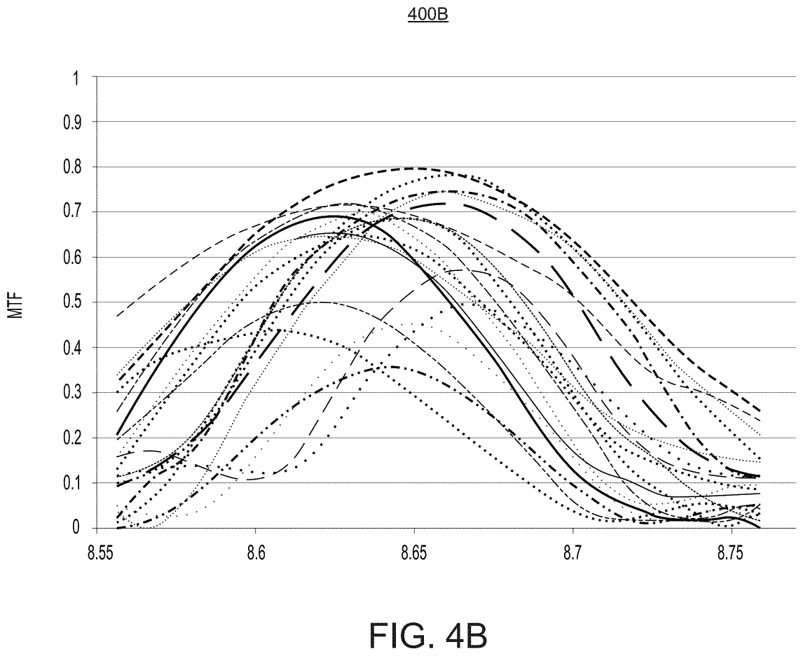

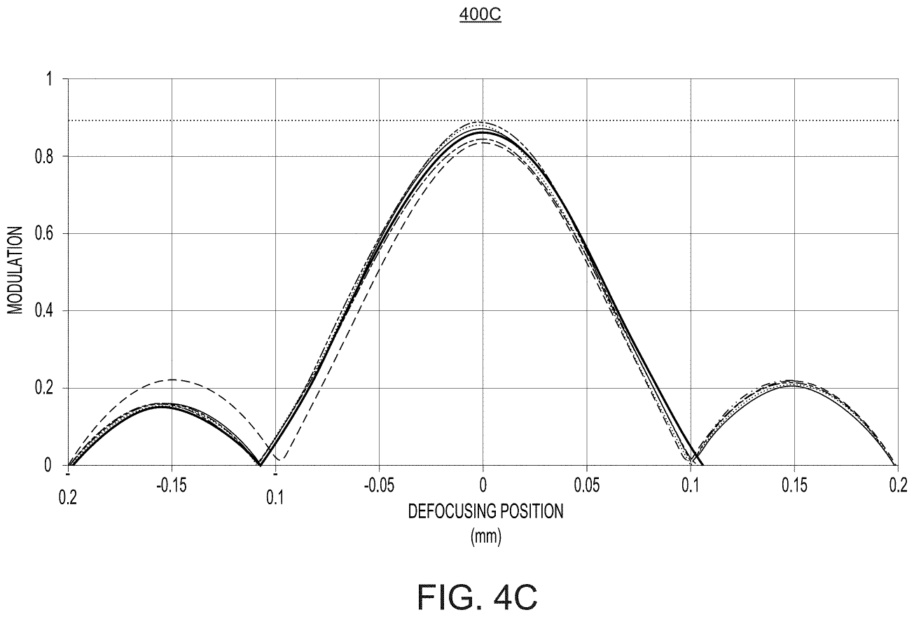

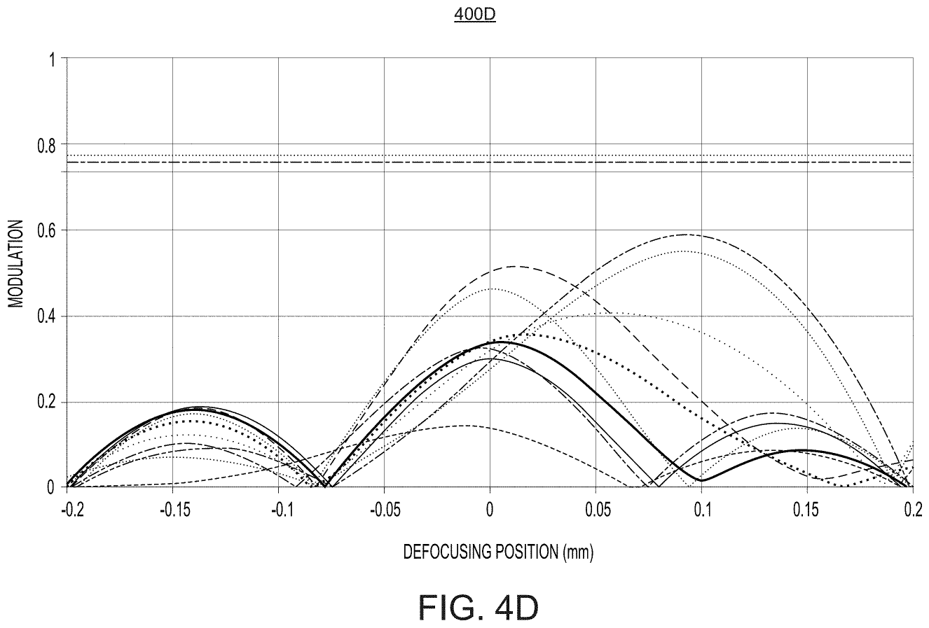

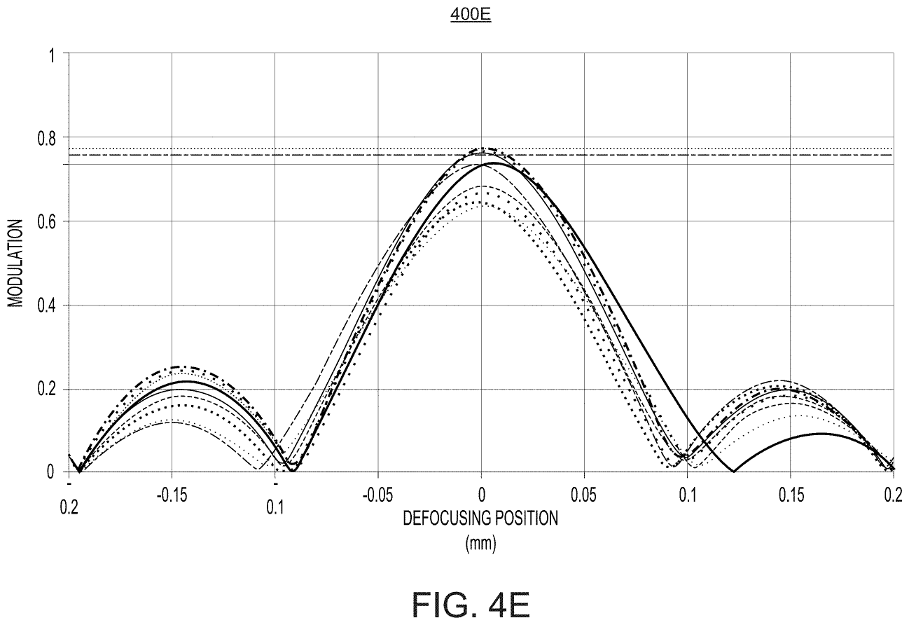

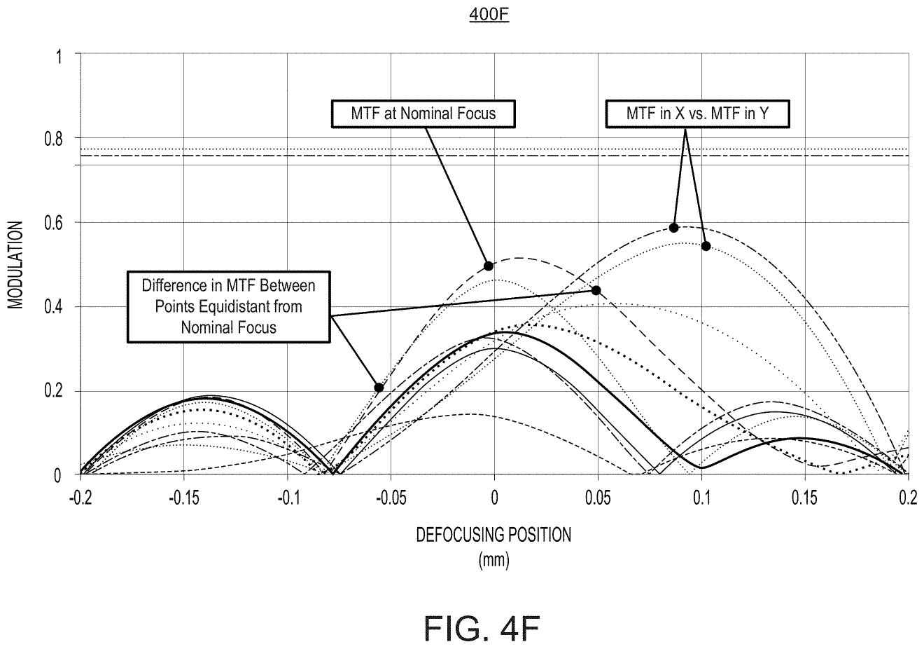

FIGS. 4A-4B illustrate graphs 400A-400B of through-focus modulation transfer function (MTF) curves for an optical assembly, according to an example. As shown in FIG. 4A, the graph 400A may depict through-focus modulation transfer function (MTF) curves for a rotationally invariant lens. It should be noted that the through-focus modulation transfer function (MTF) curves, as shown, may represent different field points and/or orientations of spatial frequency (e.g., X and Y, or sagittal and tangential). Here, the lines may appear to be relatively “well-behaved” with little variation, and the peaks of these curves all relatively aligned with one another. Based on these characteristics of the through-focus modulation transfer function (MTF) curves shown in graph 400A, it may be presumed that performance is generally high, which is commensurate with nominal performance of conventional rotationally invariant lenses.

In FIG. 4B, however, the graph 400B may depict through-focus modulation transfer function (MTF) curves for a rotationally variant lens. Here, the lines may not appear as “well-behaved” as that of the curves in the graph 400A. Furthermore, the peaks of these curves are fairly disparate and not close to being aligned with one another. Accordingly, the characteristics of the through-focus modulation transfer function (MTF) curves shown in graph 400B may therefore suggest that performance is not as high in the rotationally variant optics relative to the performance of the rotationally invariant optics, where the curves may depict better alignment and predictability. Again, this may be due, at least in part, to intrinsic higher levels of distortion in the rotationally variant lenses.

In order to optimize the lens process tuning and/or camera module integration, it may then be imperative to provide a way to generate through-focus modulation transfer function (MTF) curves for a rotationally variant lens that better resemble depict through-focus modulation transfer function (MTF) curves for a conventional rotationally invariant lens. However, there may be some challenges with this. First, it should be noted that a “best-focus” plane may not be straightforward to define. Second, in some scenarios, if significant sensor tilt is introduced in the process, a glue bond between sensor and lens may also be uneven and thereby cause thermal and/or stability issues for a camera during use. Third, adding surface fitting techniques, e.g. via software or other algorithm, however, may also add time to the already time-consuming process and ultimately generate more cost for mass production (MP) of rotationally variant optics.

To address these and other issues, the systems and methods described herein may provide high-throughput testing and module integration of rotationally variant optical lens systems. In some examples, the systems and methods may provide a nulling apparatus. The nulling apparatus may be provided, for example, using a computer-generated hologram, prism (e.g., power prism), lens and mirror elements, phase plates, or other similar components. It should be appreciated that the nulling apparatus may be configured based on a wavefront aberration profile of any given lens module, such that the generate through-focus modulation transfer function (MTF) curves from a well-made rotationally variant lens, for example, may peak within close proximity to one another. It should also be appreciated that the nulling apparatus may also change the conjugate position of the object. For example, a freeform optical system may have originally been designed to work at a close conjugate (even tilted conjugate plane) and the null apparatus may then allow the image plane to be conjugate to a larger object distance with different tilt thus making conventional modulation transfer function (MTF) curves and alignment stations to be used.

By creating, tuning, and utilizing such a nulling apparatus may enable manufacturers, suppliers, and module integrators ability to enable high-throughput lens and camera module build with relatively complete mass production compatibility. In other words, manufacturers, suppliers, and module integrators may easily and readily insert the nulling apparatus while still using existing machinery, processes, techniques, and infrastructure to provide high performing rotationally variant optical components using the techniques described herein.

To illustrate this, FIGS. 4C-4E illustrate graphs 400C-400E of through-focus modulation transfer function (MTF) curves for an optical assembly, according to an example. As shown in FIG. 4C, the graph 400C may depict diffraction modulation transfer function (MTF) curves for a rotationally symmetric camera lens. The graph 400C, for instance, may be similar to the graph 400A, where the various modulation transfer function (MTF) curves may appear relatively well-behaved, indicative of high performance.

As shown in FIG. 4D, the graph 400D may depict diffraction modulation transfer function (MTF) curves for a rotationally asymmetric (or freeform) camera lens, in this case, before application of a nulling apparatus. The graph 400D, for instance, may be similar to the graph 400B, where the various modulation transfer function (MTF) curves may not appear relatively “well-behaved.” It should be appreciated that, in some scenarios, having modulation transfer function (MTF) curves that are substantially lined up (or “well-behaved”) may be indicative of the nominal desired behavior, as described above. In some examples, the nominal design, however, may have modulation transfer function (MTF) curves that are not lined up, but this would be intentional. In other words, nominal design may have disparate modulation transfer function (MTF) curves, which may create challenges in testing. As a result, the systems and methods described herein may be directed to providing a null element that lines up the modulation transfer function (MTF) curves for purposes of testing or other similar processes.

As shown in FIG. 4E, the graph 400E may depict diffraction modulation transfer function (MTF) curves for a rotationally asymmetric camera lens, in this case, after application of a nulling apparatus. The graph 400E, for instance, may provide a “corrective” or “compensating” effect and thereby cause the various modulation transfer function (MTF) curves of the graph 400D, which were not relatively well-behaved, to now be more well-behaved and aligned. Thus, by creating, tuning, and utilizing a nulling apparatus for manufacturers, suppliers, and integrators in their existing machinery, processes, techniques, and infrastructure, may help enable high-throughput lens and camera module build with mass production compatibility.

### Creating a Nulling or Compensating Apparatus

There may be any number of systems for production-level modulation transfer function (MTF) testing. By way of example, such systems may include, but not limited to, a telescoping element, a light source (with or without collimation), a sample holder, an actuator for sample positioning (e.g., in x-, y-, and/or z-positioning), a controller, and various computing elements, such as a processor, input/output, etc. It should be appreciated that such modulation transfer function (MTF) testing systems may be dedicated machinery to provide modulation transfer function (MTF) testing functionality and features.

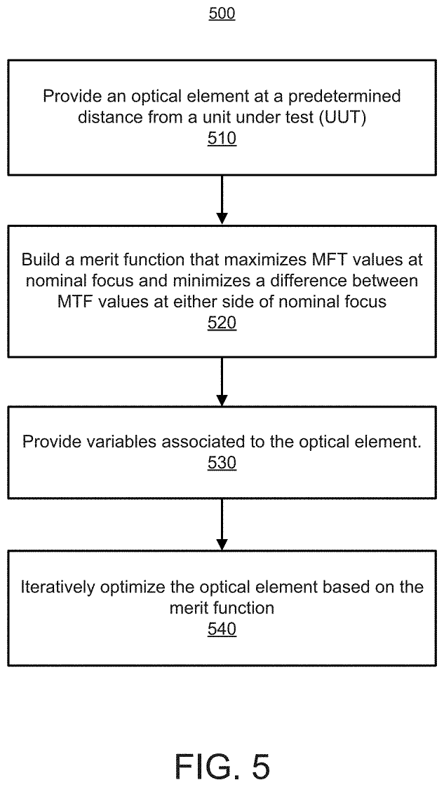

In order to create a nulling (or compensating) apparatus, there may be a number of design steps involved. FIG. 5 illustrates a flow chart of a method 500 for creating or designing a nulling apparatus or element for mass production (MP) metrology of rotationally variant optics, according to an example. The method 500 is provided by way of example, as there may be a variety of ways to carry out the method described herein. Although the method 500 is primarily described as being useful for the system 100 of FIG. 1 and/or optical lens assemblies 300A-300B of FIGS. 3A-3B, the method 500 may be executed or otherwise performed by one or more processing components of another system or a combination of systems. Each block shown in FIG. 5 may further represent one or more processes, methods, or subroutines, and one or more of the blocks may include machine readable instructions stored on a non-transitory computer readable medium and executed by a processor or other type of processing circuit to perform one or more operations described herein.

At block 510, an optical element (e.g., a compensator) may be inserted relatively faraway from a unit under test (UUT). The unit under test (UUT) may include a lens, but may also include, other components, such as a freeform prism, mirror apparatus, diffractive component, metalens, or other similar unit or component. It should be appreciated that distance may be determined by how far is needed to have sufficient separation between field points of interest, or sufficient field sampling of the modulation transfer function (MTF) (or spatial frequency response (SFR)) test target. It should also be appreciated that at this step, much care and attention should be given to help ensure a correct test target is used and that an image of the target is at the correct location on the camera sensor.

At block 520, a merit function that maximizes the modulation transfer function (MTF) values at nominal focus and minimizes the difference between modulation transfer function (MTF) values at either side of nominal focus may be built. As described above, the graph 400D of FIG. 4D may depict diffraction modulation transfer function (MTF) curves for a rotationally asymmetric (or freeform) camera lens before application of a nulling apparatus. FIG. 4F may illustrate a graph 400F, which is similar to that of the graph 400D, but with more detailed description of the various modulation transfer function (MTF) curves to help illustrate how a merit function may be built and used to maximize the modulation transfer function (MTF) values at nominal focus and minimizes the difference between modulation transfer function (MTF) values at either side of nominal focus may be built. It should be appreciated that the merit function should also maximize the overlap of modulation transfer function (MTF) curves over azimuth (e.g., the through-focus modulation transfer function (MTF) curve in the X orientation should overlap well with that in the orthogonal Y orientation), as shown.

It should be appreciated that a merit function, in general, may be described as a difference between a current state versus a desired state. As such, optimization techniques may generally seek to minimize the merit function, and thus the difference between current and desired states. Doing so would create an “optimized” condition.

In some examples of optimization, the merit function may be represented as a single number that captures one or more aspects of desired lens performance. Here, the merit function D may be constructed by taking a root means square (RMS) of all identified operands, which may be provided as follows:

$$ϕ = {\sum }_{i = 1}^{m} {{w}_{i}^{2} ( {c}_{i} - {t}_{i} )}^{2} ,$$

where m may represent a number of operands, wᵢ may represent a weighting factor for operand i, cᵢ may represent a current value for operand i, and tᵢ may represent a target value for operand i. It should be appreciated that squaring each operand may serve to magnify the operands with the worst performance and ensure that positive and negative operand values do not offset each other in sum. It should also be noted that individual operands may be relatively weighted to emphasis their desired contribution to overall performance. A target value for most operands, for example, may be zero, as described above.

So in this case, it may be desirable, for example, to have peak modulation transfer function (MTF) curves be above a certain number (e.g., 70%). Also, having a difference between the through-focus modulation transfer function (MTF) values to be minimized toward zero may also be desirable. In each case, this may be achieved using at least one weighting factor.

At block 530, variables associated with the compensator may be provided. In some examples, this may include position and orientation of the compensator. It should be appreciated that everything within the unit under test (UUT) should be kept fixed. For polynomials, it may be helpful to start with low order terms and incrementally add additional terms as needed. Example variables to be provided for the compensator may include, but not limited to: radius of curvature, conic constant, polynomial terms changing a surface shape (e.g., XY polynomials, Zernike polynomials, Forbes/Q polynomials, Legendre polynomials, etc.), diffractive/hologram parameters, phase terms, etc. Variables for position and orientation may also be provided. These may include, but not limited to: X, Y, Z, θₓ, θ_{y}, θ_{z}, or other variable. In addition, other variables to consider here may include, but not limited to, the following: material of the compensator, thickness/wedge (basically the X/Y/Z/alpha/beta/gamma position of the compensator surfaces with respect to each other), birefringence (for example, intentionally introduced stress birefringence).

It should be appreciated that these variables may not necessarily be literal mathematical variables, but parameters that may be varied or adjusted to obtain the desired merit function. For example, in an optimization scenario, one or more of these parameters may be changed or adjusted, and these changes or adjustments may affect the value of the merit function that is determined and calculated, as described above. In some examples, if the merit function value goes down with some of these changes or adjustments to these variables, then this may indicate that such changes/adjustments of these variables are desirable and to keep going to bring down the merit function. If the merit function goes up (e.g., away from zero), then this may suggest that these changes/adjustments of these variables are undesirable to reverse course to make the merit function go the other way (e.g., closer to zero).

At block 540, the nulling apparatus (or null element) may be iteratively optimized with the merit function until no significant further improvement and desired performance is achieved. In some examples, optimization may be considered when the through focus modulation transfer function (MTF) curves peak together, are generally aligned, or “well-behaved,” as described above. In other words, there may be a predetermined threshold and optimization would be determined when each field point is operating at a diffraction limit. At this point, further improvement of geometric aberrations may not necessarily provide higher modulation transfer function (MTF). Thus, modulation transfer function (MTF) would then be limited by diffraction from a beam limiting aperture(s). It should also be appreciated that it may be desirable for the compensator element to be manufacturable, which generally means that using available materials may be an important factor to make sure the null element is not too thin or too thick, the surface variation (if using polynomials) is not too abnormal, or if a computer generated hologram is used to make sure the fringe density is manufacturable with current technology (i.e., not too dense), etc. These manufacturability constraints may be applied during any optimization process.

So these manufacturability constraints should be applied during the optimization process. It should also be appreciated that optimization may be considered done when each field point is operating at its diffraction limit. At this point, further improvement of geometric aberrations would not provide higher modulation transfer function (MTF). Thus, modulation transfer function (MTF) would be limited by diffraction from the beam limiting aperture(s).

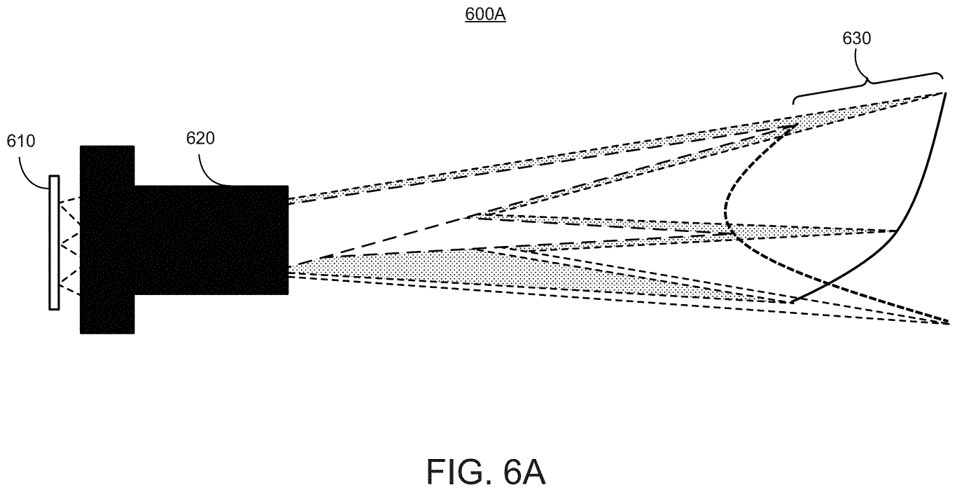

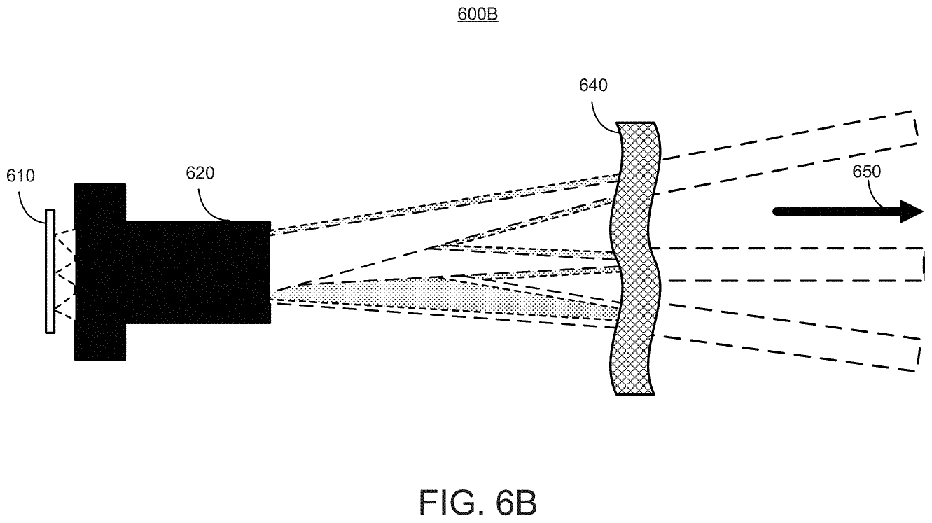

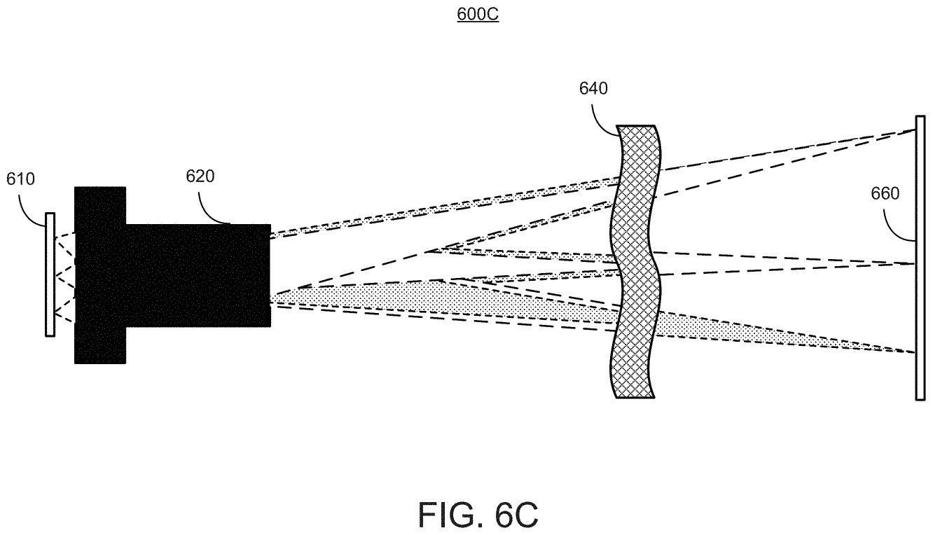

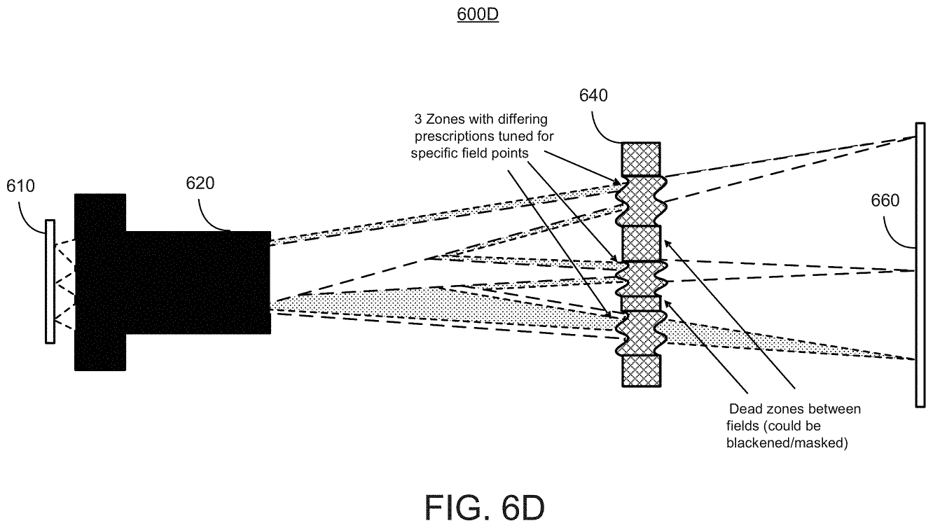

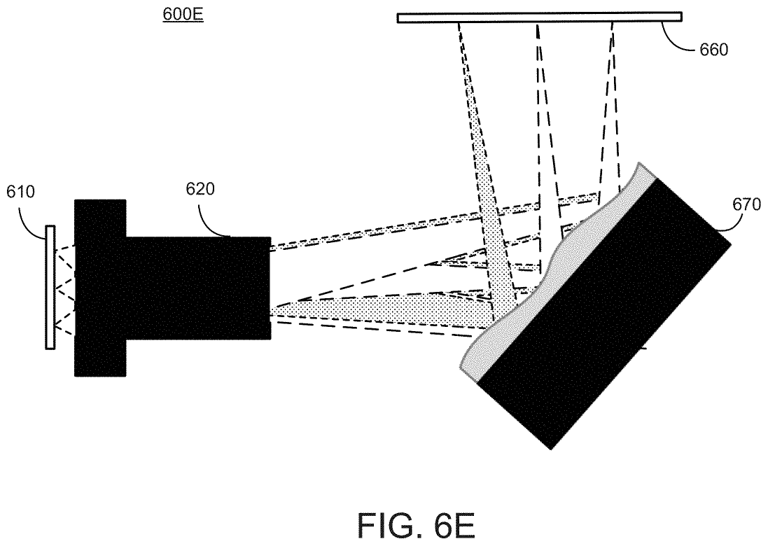

To help illustrate, FIGS. 6A-6D illustrate block diagrams 600A-600B of various optical configurations using rotationally variant optics with or without a nulling corrector, according to an example.

As shown in FIG. 6A, the block diagram 600A may depict an optical configuration having freeform lens without a null corrector. As shown, the optical configuration may include an image plane 610 and a lens module with asymmetric or freeform optics 620. It should be appreciated that at a given field, orthogonal slices 630 through the pupil may come to focus at different plans (e.g., resulting in astigmatism). In other words, different field points may come to focus at different distances from the lens. As a result, there may not be a good or appropriate place to put a target for focusing a sensor based on multiple field points.

It should be appreciated that shaded/non-shaded areas and differing dotted lanes, as shown in FIGS. 6A-6D, are used to represent one or more focus positions in orthogonal directions at each field point (i.e., astigmatism that changes as a function of field). Note that if one area is not shaded, for example, then this may imply that the two orthogonal focus points are the same. For instance, this may be true of all fields at the image plane 610 of a sensor.

As shown in FIG. 6B, the block diagram 600B may depict an optical configuration having freeform lens with a null corrector, according to an example. As shown, the optical configuration may include an image plane 610 and a lens module with asymmetric or freeform optics 620, similar to that described above. A null corrector 640, having a continuous surface description (e.g., a single/function/formula/equation) that describes surface(s) by which all or most tested field points are controlled. In contrast to FIG. 6A, the fields of FIG. 6B may be focused to infinity where standard spatial frequency response (SFR) targets can be used, e.g., to the modulation transfer function (MTF) station target projection system 650. Thus, the optical configuration of FIG. 6B may illustrate how a nulling apparatus may provide power to collimate the one or more fields (e.g., infinite conjugate to the image plane).

As shown in FIG. 6C, the block diagram 600C may depict an optical configuration having freeform lens with a null corrector, according to another example. As shown, the optical configuration may include an image plane 610 and a lens module with asymmetric or freeform optics 620, similar to that described above. FIG. 6C is also similar to FIG. 6B; however, the optical configuration here includes a nulling apparatus 640 that may provide a finite conjugate object plane (e.g., target plane) 660 for us in modulation transfer function (MTF) testing. In other words, fields may now be focus to a common object plan where standard spatial frequency response (SFR) targets can be used in this optical configuration.

As shown in FIG. 6D, the block diagram 600D may depict an optical configuration having freeform lens with a null corrector, according to another example. As shown, the optical configuration may include an image plane 610 and a lens module with asymmetric or freeform optics 620, similar to that described above. FIG. 6D is also similar to FIG. 6C; however, the optical configuration may use a null apparatus 645 having a plurality of zones or correctors that are spatially separated. As shown, the null apparatus 645 may have three zones with differing prescriptions tuned for specific field points. The null apparatus 645 may also have one or more dead zones between these three zones with differing prescriptions tuned for specific field points. In some examples, the dead zones may be blacked or provided by masks.

The optical configuration of FIG. 6D, in effect, illustrates a piecewise corrector, or a null corrector that no longer has a continuous surface but multiple correctors spatially separated. If testing is provided over a discrete number of field points, the null apparatus 645 may not need to be a continuous functional description. In other words, each spatial frequency response (SFR) target field position may have its own null corrector, as shown. Although depicted with a finite conjugate target location, it should be appreciated that the piecewise corrector configuration may also provide an infinite conjugate with a different null corrector prescription.

It should be appreciated that it may be important to have the null apparatus (or null element) or compensating element be manufacturable and usable. Accordingly, it may be important to create the null apparatus using generally available materials and making sure it is not too extreme in size, thickness, weight, or other characteristic. Furthermore, it may be important to make sure the null apparatus may have a surface variation (if using polynomials) that is not too “freeform.” If it is, it may be difficult to manufacture. For example, if a computer generated hologram is used, it may be important to make sure the fringe density is manufacturable with current technology (i.e., not too dense), etc. Thus, one or more manufacturability constraints may and should be applied during one or more steps of the optimization process described herein as well. In some examples, at least one tolerance analysis on the null apparatus may be performed to ensure that it can be fabricated so as not to cause an improper detector focus of the lens under test (LUT) or unit under test (UUT).

It should be appreciated that the process to create the nulling apparatus, as described herein, may simply be an example to facilitate mass production (MP) metrology for rotationally variant optics. For instance, the example described above may be shown for a finite or infinity conjugate setup. It should be appreciated that a finite conjugate setup may refer to imaging of objects at a “finite” distance away from a lens/camera. In contrast, an infinity conjugate setup may image objects at “infinity” distance away (e.g., a photography camera pointing toward something very far away). In other words, an infinite conjugate may be where an object distance (Z_{obj}) is many focal lengths away from a lens, e.g., Z_{obj}>>EFL (effective focal length), where the EFL may be a distance from a principal point to a focal point.

Some lenses are designed for finite conjugate while others are designed for infinite conjugates. Infinity conjugate may generally be more straightforward with an input beam being collimated/planar wavefront, whereas with finite conjugate, a lens manufacturer may have to make sure the spatial frequency response (SFR) target is positioned at the correct conjugate position/correct distance away from the lens. That said, it should be appreciated that the method or technique for creating the nulling apparatus may be applied to both infinity and finite conjugate testing configurations. Furthermore, it should be appreciated that in the general sense, the modulation transfer function (MTF)/spatial frequency response (SFR) target position and orientation may also be used as variable in optimization.

Note that in general, a lens designed for finite conjugate may not generally have good performance if used at infinity conjugate, and vice versa. The nulling compensator, described herein, may help with this as well. For example, even if a lens manufacturer only has an infinity conjugate tester, the compensation provided by the null element may still allow a finite conjugate lens to work with an infinity conjugate tester. In other words, the metrology equipment of the supplier may still be usable and a separate or distinct fully custom test apparatus may not be required, just incorporation of this null optic may be sufficient.

Although examples described above are directed to using a fabricated null apparatus or corrector, it should be appreciated that the null apparatus may not be limited to only fabricated null correctors but may also include other similar components. For example, as shown in FIG. 6E, the block diagram 600E may depict an optical configuration having freeform lens with an optical component that functions as a null corrector, according to an example. Similar to previously-described configurations, the optical configuration of FIG. 6E may include an image plane 610 and a lens module with asymmetric or freeform optics 620; however, instead of a fabricated nulling apparatus 640 or 645, the optical configuration may use a null-like apparatus 670, such as a deformable mirror (DM), a digital micromirror device (DMD), or other similar component. The null-like apparatus 670 may be tuned to provide correction over one or more field points. As shown, the null-like apparatus 670 may be positioned, for example, at a location where fields have separated footprints on a mirrored surface of the null-like apparatus 670. Here, the null-like apparatus 670 may be programed to change its shape, for instance, based on one or more actuators (or micromirrors on a DMD) and/or an associated throw/tilt range. Thus, a null-like apparatus 670 may provide a more dynamic way to correct asymmetric aberrations.

It should be appreciated that using a deformable mirror (DM) or digital micromirror device (DMD) as the null-like apparatus 670, instead of or in combination with a uniquely fabricated null optic may have several advantages. For instance, a deformable mirror (DM) or digital micromirror device (DMD) may be tuned for multiple unite under test (UUT) configurations, and not limited to any single design, which may offer a broader array of application and flexibility. Providing a deformable mirror (DM) or digital micromirror device (DMD) may also remove and minimize any challenges that may be associated with null element fabrication error and/or metrology of the null element. These and other benefits may be realized as well.

### Additional Information

The systems and methods described herein may provide a technique for creating and designing a nulling apparatus or element useful in mass production (MP) metrology of rotationally variant optical components, which, for example, may be used in a head-mounted display (HMD) or other optical applications.

The benefits and advantages of the techniques for mass production (MP) metrology of rotationally variant optical components described herein, may include, among other things, enabling manufacturers or suppliers improved techniques for iterative tuning during, for example, manufacturing of rotationally variant or freeform optics to ultimately increase quality and yield. As described above, a manufacturer may continue to use existing modulation transfer function (MTF) metrology equipment and processing techniques and simply insure the nulling apparatus between the unit under test (UUT) and spatial frequency response (SFR) target projection system. Moreover, the systems and methods described herein may also provide high-throughput testing and integration for camera and sensor modules, which in turn may have benefits in optical power customizability while minimizing overall lens assembly thickness, reducing power consumption, increasing product flexibility and efficiency, and improved resolution. This may be achieved in any number of environments, such as in virtual reality (VR), augmented reality (AR), and/or mixed reality (MR) environments, or other optical scenarios.

As mentioned above, there may be numerous ways to configure, provide, manufacture, or position the various optical, electrical, and/or mechanical components or elements of the examples described above. While examples described herein are directed to certain configurations as shown, it should be appreciated that any of the components described or mentioned herein may be altered, changed, replaced, or modified, in size, shape, and numbers, or material, depending on application or use case, and adjusted for desired resolution or optimal results. In this way, other electrical, thermal, mechanical and/or design advantages may also be obtained.

It should be appreciated that the apparatuses, systems, and methods described herein may facilitate more desirable headsets or visual results. It should also be appreciated that the apparatuses, systems, and methods, as described herein, may also include or communicate with other components not shown. For example, these may include external processors, counters, analyzers, computing devices, and other measuring devices or systems. In some examples, this may also include middleware (not shown) as well. Middleware may include software hosted by one or more servers or devices. Furthermore, it should be appreciated that some of the middleware or servers mayor may not be needed to achieve functionality. Other types of servers, middleware, systems, platforms, and applications not shown may also be provided at the back-end to facilitate the features and functionalities of the headset.

Moreover, single components described herein may be provided as multiple components, and vice versa, to perform the functions and features described above. It should be appreciated that the components of the apparatus or system described herein may operate in partial or full capacity, or it may be removed entirely. It should also be appreciated that analytics and processing techniques described herein with respect to manufacturing or sensor integration of rotationally variant optical components, for example, may also be performed partially or in full by these or other various components of the overall system or apparatus.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and/or interfaces, may be any number of optical, mechanical, electrical, hardware, network, or software components, circuits, elements, and interfaces that serves to facilitate communication, exchange, and analysis data between any number of or combination of equipment, protocol layers, or applications. For example, some of the components described herein may each include a network or communication interface to communicate with other servers, devices, components or network elements via a network or other communication protocol.

Although examples are generally directed to head-mounted displays (HMDs), it should be appreciated that the apparatuses, systems, and methods described herein may also be used in other various systems and other implementations. For example, these may include other various head-mounted systems, eyewear, wearable devices, optical systems, etc. in any number of virtual reality (VR), augmented reality (AR), and/or mixed reality (MR) environments, or beyond. In fact, there may be numerous applications in various optical or data communication scenarios, such as optical networking, image processing, spectroscopy, telescoping technologies, etc.

It should be appreciated that the apparatuses, systems, and methods described herein may also be used to help provide, directly or indirectly, measurements for distance, angle, rotation, speed, position, wavelength, power, shape, transmissivity, and/or other related optical measurements. For example, the systems and methods described herein may allow for a higher optical resolution and increased system functionality using an efficient and cost-effective design concept. With additional advantages that include higher resolution, lower number of optical elements, more efficient processing techniques, cost-effective configurations, and smaller or more compact form factor, the apparatuses, systems, and methods described herein may be beneficial in many original equipment manufacturer (OEM) applications, where they may be readily integrated into various and existing equipment, systems, instruments, or other systems and methods. The apparatuses, systems, and methods described herein may provide mechanical simplicity and adaptability to small or large headsets. Ultimately, the apparatuses, systems, and methods described herein may increase resolution, minimize adverse effects of traditional systems/approaches, and improve visual efficiencies.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A metrology system, comprising:
a light source to generate optical illumination;
a null apparatus to generate, using the optical illumination from the light source, a prescribed wavefront corresponding to a unit under test (UUT); and
a null apparatus fixture to position the null apparatus with respect to the unit under test (UUT).

2. The metrology system of claim 1, further comprising:
an output to provide one or more through-focus modulation transfer function (MTF) curves based on the generated prescribed wavefront corresponding to the unit under test (UUT), wherein the one or more through-focus modulation transfer function (MTF) curves correspond to different field points and different modulation orientations.

3. The metrology system of claim 2, wherein the one or more through-focus modulation transfer function (MTF) curves are used in rotationally variant optical component manufacturing or sensor module integration.

4. The metrology system of claim 1, wherein the unit under test (UUT) comprises a rotationally variant or freeform optical element.

5. The metrology system of claim 1, wherein the null apparatus is provided using at least one of a hologram, a phase plate, a lens, a prism, or a mirror element.

6. The metrology system of claim 1, wherein the metrology system is configured in at least one of an infinity conjugate optical testing configuration or a finite conjugate optical testing configuration.

7. The metrology system of claim 1, wherein:
the null apparatus comprises at least of a fabricated null element, a deformable mirror (DM), a digital micromirror device (DMD); and
the unit under test (UUT) is used in an optical assembly as part of a head-mounted display (HMD) used in at least one of a virtual reality (VR), augmented reality (AR), or mixed reality (MR) environment.

8. A method for creating a null apparatus for metrology of rotationally variant optics, comprising:
providing an optical element at a predetermined distance from a unit under test (UUT);
build a function to maximize through-focus modulation transfer function (MTF) values at a nominal focus and minimize a difference between through-focus modulation transfer function (MTF) values at either side of nominal focus; and
iteratively optimize the optical element based on the function.

9. The method of claim 8, wherein the optical element is a compensating element.

10. The method of claim 8, wherein the predetermined distance is based on at least one of separation between field points of interest, pupil sampling, or sufficient field sampling of through-focus modulation transfer function (MTF) test target.

11. The method of claim 10, wherein the through-focus modulation transfer function (MTF) test target is based on an image from a camera sensor.

12. The method of claim 8, wherein the function is a merit function.

13. The method of claim 12, wherein the merit function further maximizes an overlap of modulation transfer function (MTF) curves over azimuth.

14. The method of claim 8, wherein building the function further comprises establishing one or more variables associated with the optical element.

15. The method of claim 14, wherein the one or more variables comprise at least one of position, orientation, radius of curvature, conic constant, surface shape, diffractive parameter, holographic parameter, or phase term.

16. The method of claim 15, wherein the surface shape is expressed as a grid of control points or a polynomial, wherein the grid of control points represents grid-type freeform surfaces comprising at least one of a non-uniform rational B-spline (NURB) or grid sag, and wherein the polynomial represents a closed form function comprising at least one of XY polynomials, Zernike polynomials, Forbes/Q polynomials, or Legendre polynomials.

17. The method of claim 8, wherein iteratively optimizing the optical element based on the function is based on meeting a predetermined threshold.

18. A non-transitory computer-readable storage medium having an executable stored thereon, which when executed instructs a processor to perform the following:
provide an optical element at a predetermined distance from a unit under test (UUT);
build a function to maximize through-focus modulation transfer function (MTF) values at a nominal focus and minimize a different between through-focus modulation transfer function (MTF) values at either side of nominal focus; and
iteratively optimize the optical element based on the function.

19. The non-transitory computer-readable storage medium of claim 18, wherein the function is a merit function that maximizes an overlap of modulation transfer function (MTF) curves over azimuth.

20. The non-transitory computer-readable storage medium of claim 18, wherein building the function further comprises establishing one or more variables associated with the optical element, wherein the one or more variables comprise at least one of position, orientation, radius of curvature, conic constant, surface shape, diffractive parameter, holographic parameter, or phase term.
